(19) United States
(12) Patent Application Publication
(10) Pub. No.: US 2016/0348889 A1
(43) Pub. Date: Dec. 1, 2016

(54) ATHLETIC WEAR ILLUMINATION

(71) Applicant: Timothy Ryan Polanowski, Towson, MD (US)

(72) Inventor: Timothy Ryan Polanowski, Towson, MD (US)

(21) Appl. No.: 14/877,847

(22) Filed: Oct. 7, 2015

Related U.S. Application Data
(60) Provisional application No. 62/166,650, filed on May 26, 2015.

(51) Int. Cl. F21V 33/00; F21S 4/22; A41D 1/08; A41D 1/00; A41F 9/00; A41D 13/00

(52) U.S. Cl. CPC F21V 33/0008; A41F 9/002; A41D 13/0015; A41D 1/08; A41D 1/002; F21S 4/22; F21Y 2101/02; F21Y 2103/003

(57) ABSTRACT

An athletic wear illumination system. The athletic wear illumination system may comprise a belt illumination device and a track-mounted lower body garment. The belt illumination device may include a belt and at least one illumination strand extending from the belt. The at least one illumination strand may be adapted to be removably received within a corresponding at least one track attached to the track-mounted lower body garment.

### RELATED APPLICATION

This application is a non-provisional application of prior pending U.S. Provisional Patent Application Ser. No. 62/166,650, filed May 26, 2015, and entitled “ATHLETIC WEAR ILLUMINATION”, which is herein incorporated by reference in its entirety.

### BACKGROUND

1. Field

Embodiments of the present invention relate generally to the field of garments and particularly to illuminated athletic wear used by runners, bikers, and other non-contact sport athletes.

2. Description of the Related Art

Many exercise enthusiasts do not have the ability to dictate the time of the day for which they workout. This may be due to multiple factors including work schedule requirements, commute times, and even environmental considerations. For example, many work traditional work hours and have long commute times to and from work. Still others may live in a relatively hot environment where it is difficult to run during the heat of the day. In each of these situations, athletes may have no alternative other than to exercise at night. Also, there may be places and/or events where the lack of lighting is not optimal for the safety of the athlete. Athletic wear is typically designed principally with comfort of the athlete in mind. For example, running pants may be designed to be lightweight and to pull moisture away from the skin. Accordingly, running pants are often tight fitting and made of a stretchable moisture wicking material. Many current offerings are black or a dark gray which may be difficult for others to see at night. Dark color offerings are certainly not the rule, and in fact there are many offerings that are designed with style in mind (e.g., having stylish patterns and bright colors). However, even these stylish and colorful running pants may be difficult for others to see at night. If others (e.g., such as those operating automobiles) are unable to clearly see an athlete running at night, then there is an increased safety risk for the athlete.

In light of the foregoing and other shortcomings in the art, it is desirable to provide improved athletic wear.

### BRIEF SUMMARY

It is an aspect of the present invention to provide illuminated athletic wear.

In accordance with an aspect of the present invention, an athletic wear illumination system may be provided. The athletic wear illumination system may comprise a belt illumination device and a track-mounted lower body garment. The belt illumination device may include a belt and at least one illumination strand extending from the belt. The at least one illumination strand may be adapted to be removably received within a corresponding at least one track attached to the track-mounted lower body garment.

The at least one illumination strand may comprise a plurality of illumination strands, and the corresponding at least one track may comprise a corresponding plurality of tracks.

The at least one track may comprise at least one member of the group consisting of a transparent cylindrical channel, a flexible dove-tail channel, a series of receptacles, and a series of magnets.

The at least one illumination strand may comprise a string or line of Light Emitting Diode (LED) lights.

The at least one illumination strand may comprise electroluminescent lighting (EL).

The at least one track may begin at or below a beltline of the track-mounted lower body garment and may extend down the track-mounted lower body garment to a position at or above a bottom of the track-mounted lower body garment.

The foregoing and other aspects will become apparent from the following detailed description when considered in conjunction with the accompanying drawing figures.

### BRIEF DESCRIPTION OF THE DRAWINGS

FIG. 1 is a side view of an athletic wear illumination system according to an embodiment of the present invention.

FIG. 2 is a partial front view of the athletic wear illumination system of FIG. 1.

FIG. 3 is a rear view of the athletic wear illumination system of FIG. 1.

FIG. 4 is a front view of a belt illumination device according to an embodiment of the present invention.

FIG. 5 is a top view of the belt illumination device of FIG. 4.

FIG. 6 is a perspective view of a belt illumination device according to another embodiment of the present invention.

FIGS. 7A-7D are partial views of tracks according to exemplary embodiments of the present invention.

FIGS. 8A and 8B are cutaway views of tracks according to exemplary embodiments of the present invention.

FIG. 9 is a side view of an athletic wear illumination system according to another embodiment of the present invention.

FIG. 10 is a perspective view of a belt illumination device according to another embodiment of the present invention.

### DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

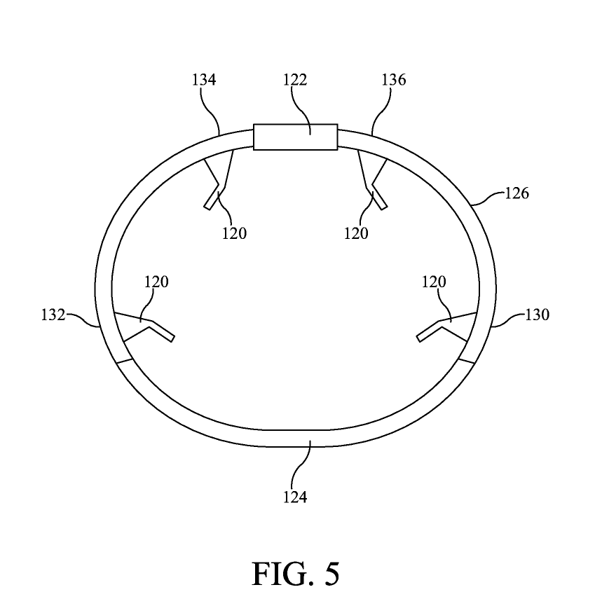

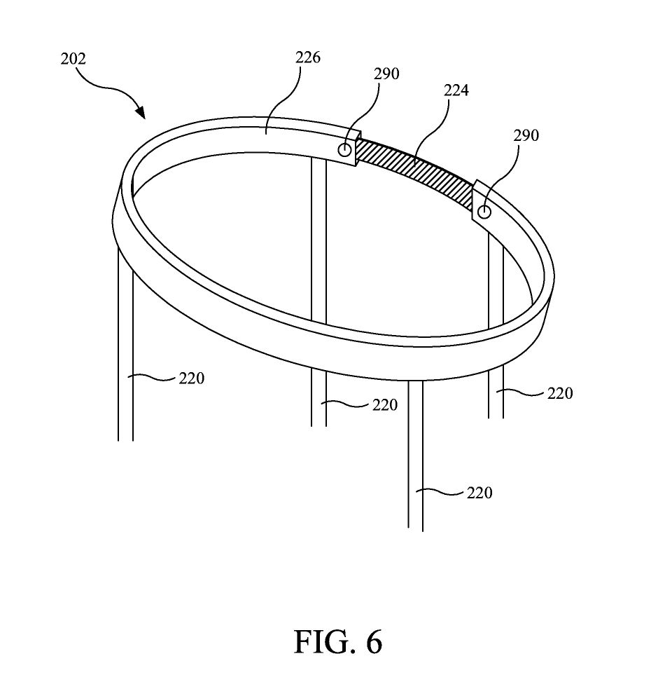

As used in the description of this application, the terms “a”, “an” and “the” may refer to one or more than one of an element (e.g., item or act). For example, references to “a track” may refer to one or more tracks. Similarly, a particular quantity of an element may be described or shown while the actual quantity of the element may differ. The terms “and” and “or” may be used in the conjunctive or disjunctive sense and will generally be understood to be equivalent to “and/or”. Elements from an embodiment may be combined with elements of another. For example, aspects of the belt illumination device of FIG. 5 may be incorporated into the belt illumination device of FIG. 6, and vice versa. No element used in the description of this application should be construed as critical or essential to the invention unless explicitly described as such. Further, when an element is described as “connected,” “coupled,” or otherwise linked to another element, it may be directly linked to the other element, or intervening elements may be present.

In accordance with embodiments of the present invention, athletes having to run, bike, walk, or otherwise exercise at night may illuminate their athletic wear such that the athletic wear remains comfortable, affordable, and washable. According to an embodiment of the present invention, an athletic wear illumination system may be provided. The athletic wear illumination system may include a belt-illumination device and a track-mounted lower body garment. The belt-illumination device may include a belt and at least one illumination strand extending from the belt, said at least one illumination strand being adapted to be received within a corresponding at least one track attached to the track-mounted lower body garment. The track-mounted lower body garment may comprise athletic pants or shorts having the at least one track attached thereto, said at least one track being adapted to receive the illumination strand of the belt illumination device. The belt-illumination device and track-mounted lower body garment may be provided in different sizes including different waist sizes and lengths.

In an embodiment, the belt-illumination device may include four illumination strands and the track-mounted lower body garment may include four tracks corresponding to the four illumination strands. Once the belt illumination device is attached at the waist of an athlete, the athlete may easily guide the four illumination strands of the belt-illumination device into or onto the four tracks of the track-mounted lower body garment. Accordingly, the athletic wear illumination system may provide a system whereby illumination strands of a belt may be attached to the track-mounted lower body garment. After the athlete is finished exercising, the athlete may unfasten the belt illumination device and by pulling the device away from the waist, the four illumination strands may easily come out of or off of the four tracks. The belt-illumination device may be interchangeable with various track-mounted lower body garments. Similarly, the track-mounted lower body garment may be interchangeable with various belt-illumination devices.

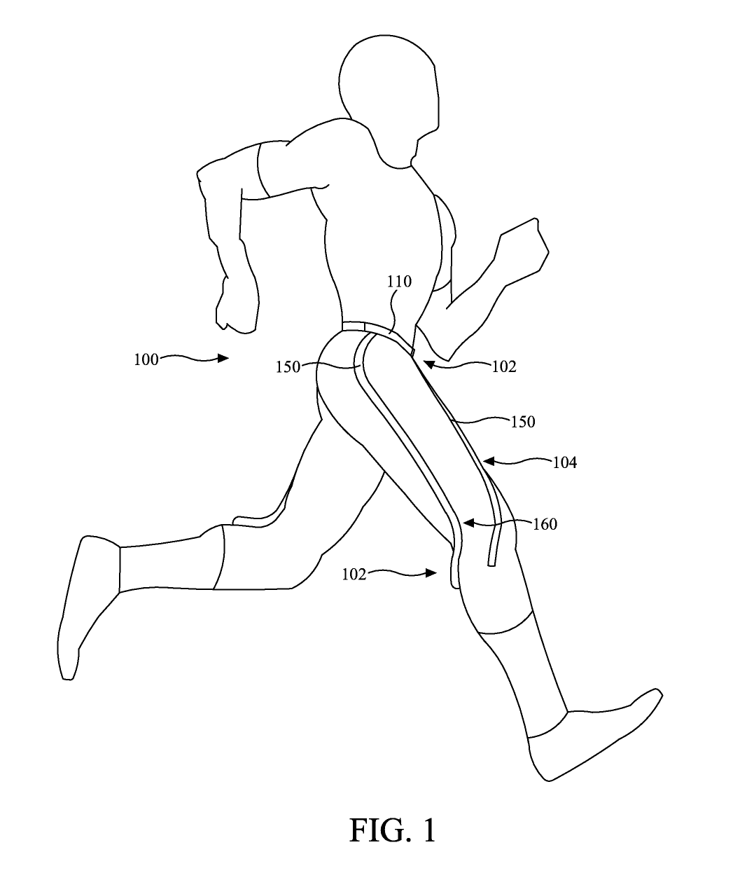

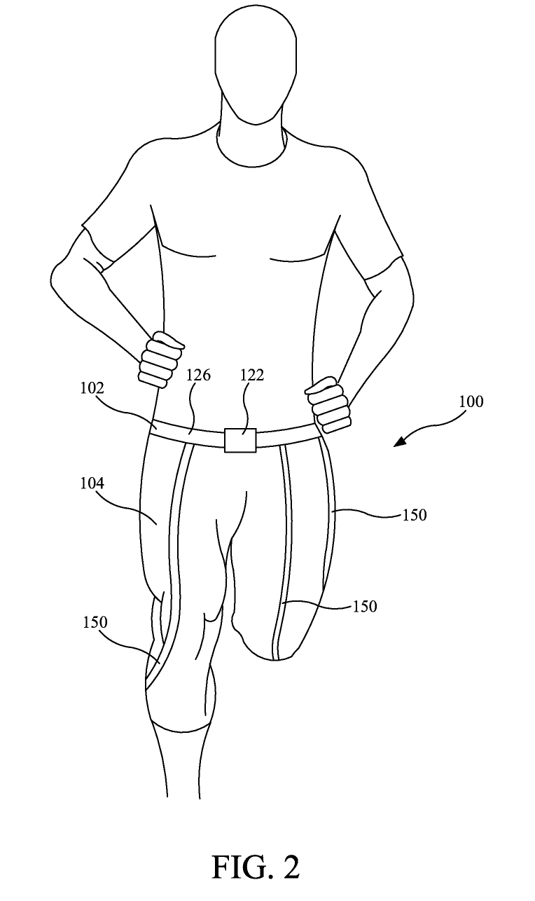

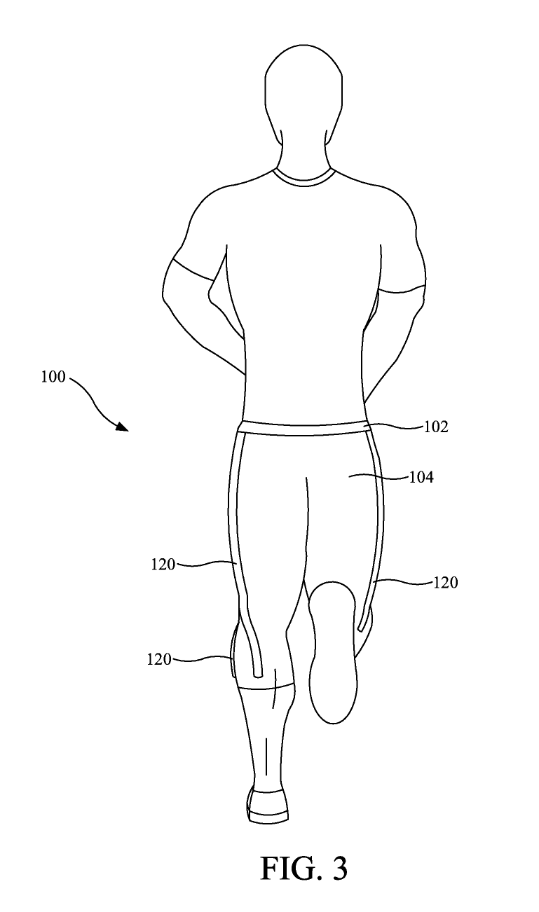

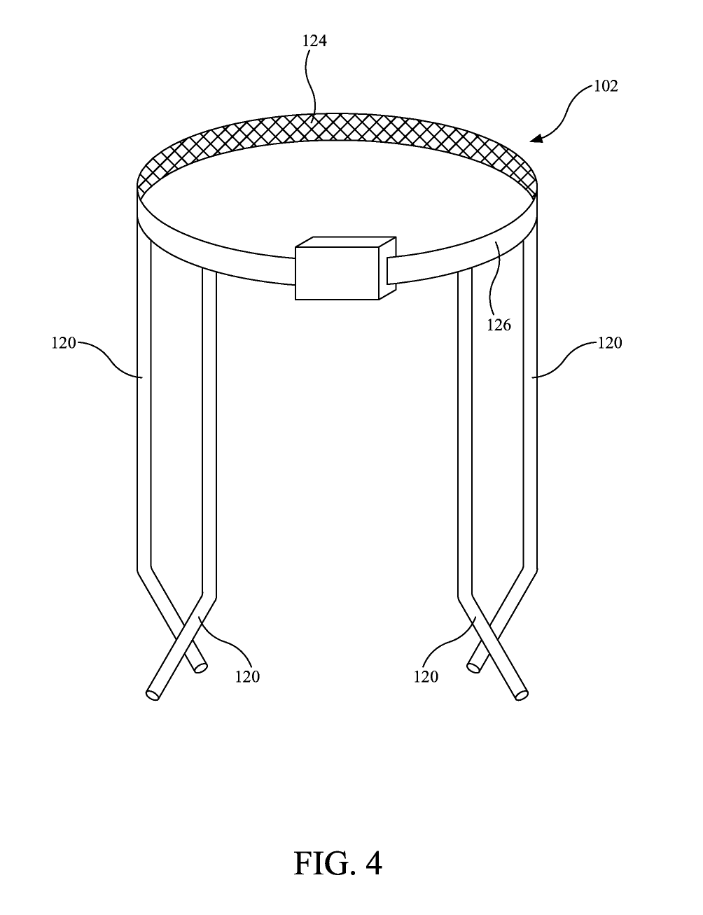

FIG. 1 is a side view an athletic wear illumination system 100 according to an embodiment of the present invention. FIG. 2 is a partial front view of the athletic wear illumination system 100 of FIG. 1. FIG. 3 is a rear view of the athletic wear illumination system 100 of FIG. 1. With references to FIGS. 1-3, the athletic wear illumination system 100 may include a belt illumination device 102 and a track-mounted lower body garment 104. The belt illumination device 102 may include a belt and at least one illumination strand 120 (FIG. 4) extending from the belt. In the embodiment shown, the belt illumination device 102 includes four illumination strands. By including four illumination strands 120 arranged within tracks 150 of the track-mounted lower body garment 104 as discussed below, visibility of an athlete wearing the athletic wear illumination system 100 from four sides (i.e., 360 degrees) can be achieved.

The track-mounted lower body garment 104 may comprise athletic pants or shorts (e.g., running pants or shorts) having at least one track 150 attached thereto. In the embodiment shown, the track-mounted lower body garment 104 is a pair of ¾ running pants including four tracks. However, alternative configurations are considered to be within the scope of the present invention. For example, the track-mounted lower body garment 104 may be a pair of running shorts or full length pants, and may have an alternative number of tracks such as two tracks. The track-mounted lower body garment 104 may be made from a stretchable moisture wicking material or other suitable material. For example, the track-mounted lower body garment 104 may be formed from one or more of polyester, spandex, nylon, cotton, or other suitable materials. The track-mounted lower body garment 104 may be washable and dryable in a household clothes washer and dryer.

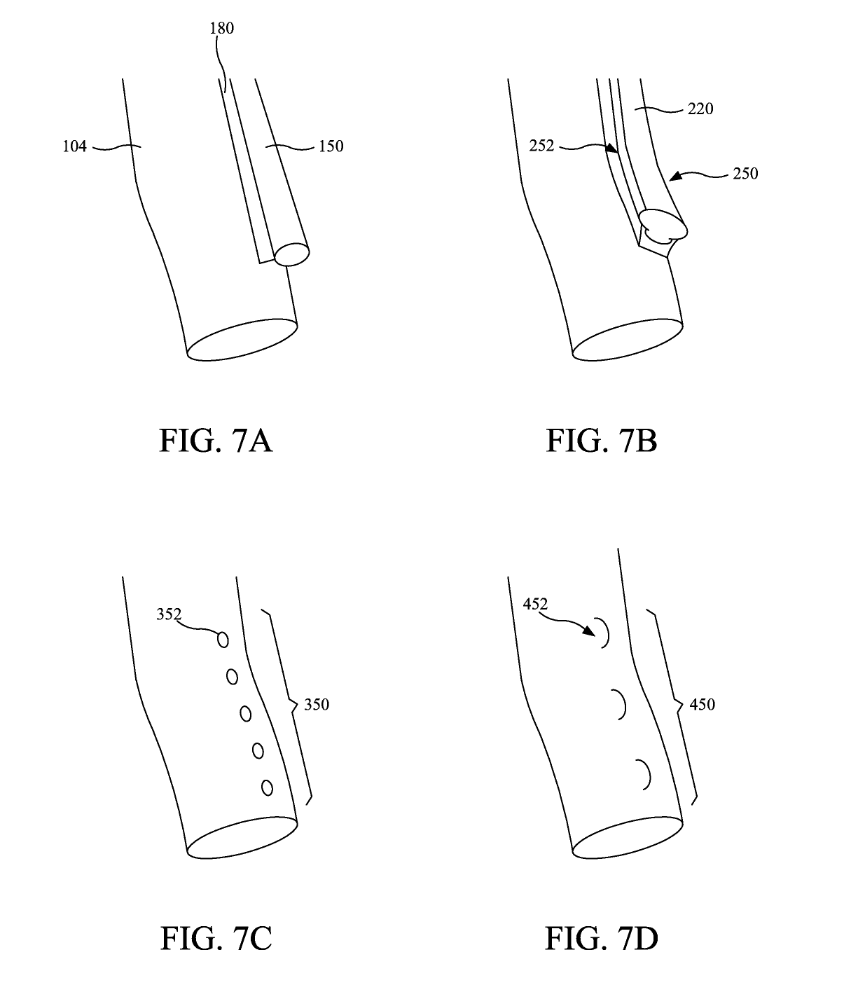

The tracks 150 may be adapted to receive the illumination strands 120 of the belt illumination device 102. In this way, the belt illumination device 102 may be attached to the track-mounted lower body garment 104. Turning to FIG. 7A, which is a partial view of a track 150 according to an embodiment of the present invention, the tracks 150 may be attached to the track-mounted lower body garment 104. In the embodiment shown, the track 150 includes a channel formed from rubberized plastic. The track may be ⅜ inch wide, though one of skill in the art will appreciate that this may vary depending on the size of the illumination strand. The channel may be open at both ends (at or near a beltline of the track-mounted lower body garment 104 and at a bottom end of the channel). However, alternative configurations are considered to be within the scope of the present invention. For example, the bottom end of the channel may be closed. The channel may be transparent or semi-transparent so as to allow light to pass through the channel. Alternative channel designs are contemplated and are considered to be within the scope of the present invention. For example, a channel may be formed of fabric that lets light pass through. In yet another alternative embodiment, a channel may be formed of transparent or translucent tubing. In yet another alternative embodiment, a channel may be formed of a screen material. In yet another alternative embodiment, a color tinted transparent or semitransparent channel may be provided to cooperate with a white or clear illumination strand.

The channel may be fastened to the track-mounted lower body garment 150, directly, or by a connecting member 180. In the embodiment shown, the channel is permanently attached to the track-mounted lower body garment 150 by sewing the channel to a fabric strip connecting member 180 that runs the length of the channel, and by sewing the fabric strip connecting member 180 to the track-mounted lower body garment 104. By incorporating the fabric strip connecting member 180 in-between the channel and the track-mounted lower body garment 104, the track 150 may be less restrictive to the athlete during use, even when the track 150 contains a corresponding illumination strand 120. Further, the fabric strip connecting member 180 may allow the fabric of the track-mounted lower body garment to stretch without stretching the channel of the track 150. In the embodiment shown, the fabric strip connecting member 180 may be formed of the same material as the track-mounted lower body garment 104 and may be ⅜ inch wide, though other sizes are considered to be within the scope of the present invention. Although a particular channel/connecting member/garment construction has been disclosed, alternative configurations are considered to be within the scope of the present invention. For example, a channel may be affixed directly to the track-mounted lower body garment. In yet another alternative embodiment, a plurality of fastening strips (such as hook and loop fastening strips) may be used to fasten a channel to the track-mounted lower body garment, or to directly fasten the illumination strand to the track-mounted lower body garment (in which embodiment the plurality of fastening strips may constitute the channel). Turning back to the channel/connecting member/garment arrangement, the channel and the connecting member may be referred to herein collectively as the track 150.

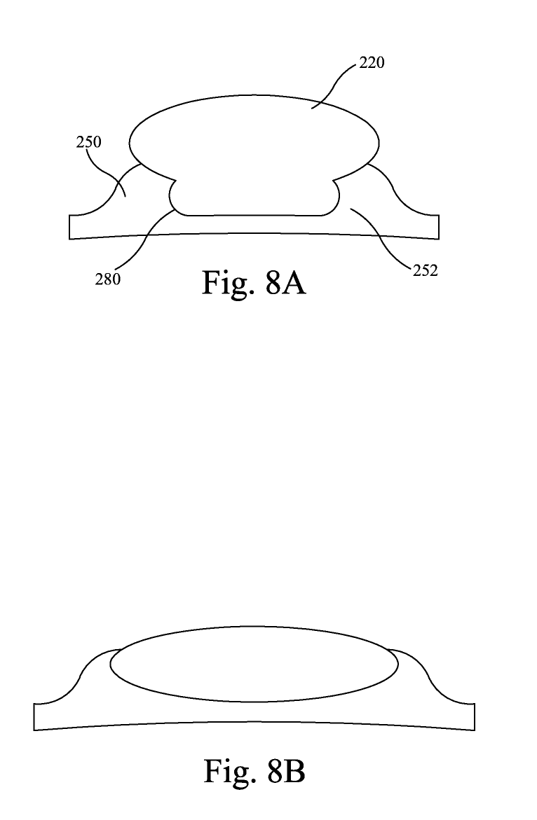

FIG. 7B is a partial view of a track 250 according to another embodiment of the present invention. FIG. 8A is a cutaway view of the track 250 of FIG. 7B with an illumination strand 120 received therein. The track 250 may be attached to the tracked-mounted lower body garment 104. In the embodiment shown, the track 250 includes a dove-tail channel 252 formed of rubberized plastic. Because the track 250 may be formed of rubberized plastic, the track 250 may be flexible. In one embodiment, the track may be formed of a mix of polypropylene and ethylene propylene diene monomer rubber. In another embodiment, the track may be formed of thermoplastic vulcanizate. In yet another embodiment, the track may be formed of thermoplastic polyolefin. In yet another embodiment, the track may be formed of chlorinated neoprene. As shown in FIG. 8A, the dove-tail channel may be ¼ to ½ inches wide internally, ⅜ to ⅝ inches tall, and of a convex or semi-circular shape, though one of skill in the art will appreciate that this may vary depending on the size and shape of the illumination strand. For example, as shown in FIG. 8B, the dove-tail channel may be ½ to ¾ inches wide internally, ¾ to 1¼ inches wide externally, and ⅜ to ⅝ inches tall. The illumination strand may be may be formed of a clear flexible material and include a dove-tail feature 280 corresponding to the dove tail channel 252 such that the illumination strand may mate to the track 250. Alternative sizes, shapes, and configurations are contemplated and are considered to be within the scope of the present invention. For example, a track may have an oblong shape and a track may have a corresponding channel.

The track 250 may be fastened to the track-mounted lower body garment 104 (204), directly, or by a connecting member (not shown). In the embodiment shown, the track 250 is permanently attached to the track-mounted lower body garment 104 by sewing the track 250 directly to the track-mounted lower body garment 104. As noted above, the track 250 may be formed of rubberized plastic and may therefore be flexible.

FIGS. 7C and 7D are partial views of tracks 350 and 450 according to further alternative embodiments of the present invention. The track 350 of FIG. 7C may be formed of a plurality of receptacles 352 while the track 450 of FIG. 7D may be formed of a plurality of magnets 452. In an embodiment, the receptacles 352 may be configured to receive a series of plastic clips molded with or otherwise attached to an illumination strand. In an alternative embodiment, the receptacles 352 and clips may constitute snap fasters, that is, pairs of interlocking discs. Turning to FIG. 7D, the plurality of magnets 452 may be embedded within the track-mounted lower body garment 104. In the embodiments shown in FIGS. 7C and 7D (and their alternatives), the buttons may be spaced an appropriate distance apart from one another and in a desire line (e.g., having one or more desired curves so as to provided desired visibility for the athlete.

In the embodiment shown, the track-mounted lower body garment 104 may include two pant legs extending from the users hips to midway down the user's calf, and a waist section that extends from the waist to where the two pant legs start. The at least one track 150 may be placed intentionally for athlete comfort and for increasing visibility of the athlete to others. In the embodiment shown, four tracks 150 are shown. Each of the four tracks 150 starts from below a beltline of the track-mounted lower body garment and each may run downward from below the beltline, as described below after the belt illumination device 102 is described.

FIG. 4 is a front view of a belt illumination device 102 according to an embodiment of the present invention. FIG. 5 is a top view of the belt illumination device of FIG. 4. In the embodiment shown, the belt illumination device 102 includes a buckle 122, a belt, and at least one illumination strand 120. One of ordinary skill in the art will appreciate that the belt of the belt illumination device 102 is depicted in a circular shape in FIG. 5 for the sake of discussion, but that in operation, the belt will take the shape of its user. In the embodiment shown, the belt comprises a stretch portion 124 and two non-stretch portions 126. However, alternative configurations are considered to be within the scope of the present invention. For example, the belt may comprise a single portion, two portions (as described below with respect to the embodiment of FIG. 6), or more portions. The belt may include the stretch portion in addition to the non-stretch portion so that the belt illumination device 102 may be worn comfortably and snug at the waist without requiring belt loops (though an embodiment of a track-mounted lower body garment including belt loops is considered to also be within the scope of the present invention). In another embodiment, a belt portion that is a partial belt may be provided.

In the embodiment shown in FIGS. 4 and 5, a first of the non-stretch portions 126 may extend from a position behind (e.g., relative to the buckle 122, ½ inch behind) where one of the rear illumination strands 120 extends from the non-stretch portion 126 to the buckle 122. A second of the non-stretch portions 126 may extend from the buckle 122 to a position beyond where another one of the rear illumination strands 120 extends from the non-stretch portion 126. The stretch portion 124 may extend from the first non-stretch portion 126 to the second non-stretch portion on the back side of the belt. In other words, the stretch portion 124 may extend on the rear of the belt from a position before (e.g., from a position ½ inch before) where one of the rear illumination strands extends from the first non-stretch portion 126 to a position before (e.g., from a position ½ inch before) where anther one of the rear illumination strands extends from the second non-stretch portion. The non-stretch portions 126 may be formed of a rubberized plastic. The stretch portion 124 may be formed of an elastic material (e.g., a rubber material with or without a fabric surrounding the rubber material) to ensure fit and comfort of the belt for the user. However, alternative configurations are considered to be within the scope of the present invention. For example, the non-stretch portions may be formed of a hard plastic, or woven cotton and the stretchable portion may be formed of an alternative stretchable material. The non-stretch and/or stretch portions may be substituted with a semi-flexible molded rubber and include wiring therein. Such an embodiment may be flexible to the precise shape of the athlete's body, but also provide a structure for wiring between a power supply and the illumination strands.

In the embodiment shown, the belt illumination device 102 including the belt and the at least one illumination strand 120 are formed as a unitary structure. For example, the illumination strands may be attached to the belt by means of a fastener or alternatively by adhesive. As yet another alternative, the illumination strands may be attached to the belt by means of a friction fit. As yet additional alternatives, the illumination strands may be attached by means of sewn, melted, in situ molded, to the non-stretch portions of the belt. However, alternative configurations are considered to be within the scope of the present invention. For example, the belt illumination device may include at least one illumination strand that is removable from the belt portion such as via a plug and/or fastener assembly. In one embodiment, axial plugs with a retaining structure such as a clip may be provided. Alternatives such as spring devices, snaps, magnetic connectors or other connection methods may be employed.

The buckle 122 may contain one or more batteries. The buckle may be weatherproof. The buckle may be formed of a rubberized and/or hard plastic. In the embodiment shown, four 2016 (e.g., CR2016) lithium batteries may be arranged 2×2 side by side thereby supplying 12 volts. However, alternative configurations are considered to be within the scope of the present invention. For example, one or more non-lithium batteries may be used, as may other types of lithium batteries providing the same or other levels of voltage (e.g., 6 volts). In general, a specific power source may be determined by balancing a desire for less weight (so as to not hinder the motion and comfort of the athlete) against the need to effectively illuminate the illumination strands and a desire for longer battery life (thereby requiring less charging). In yet another embodiment, a motion power generator is used to generate power from the motion of the athlete in place of batteries. The shape of the buckle shown is rectangular, however: any shape suitable for housing the batteries may be employed.

The batteries may be operably connected to the at least one illumination strand 120. In the embodiment shown, the batteries may be operably connected to the illumination strands 120 via, e.g., encased 18-22 gauge stranded copper wires (or other appropriate size and material wire) extending through the non-stretch portions 126 of the belt to the light strands 120. Elements such as the illumination strand may be connected to the wire by flux and solder or other appropriate connection types, and may be covered by a rubberized protection to reduce the chance of an electrical short due to athlete sweat or weather. In the embodiment shown, the wires may be embedded within the non-stretch portions 126 of the belt. In the embodiment shown, the buckle 122 may be permanently or fixedly attached to either the first or second non-stretch portion 126 and adapted to be operably connected to the other. For example, the buckle 122 may include a female member to receive a male member of one of the non-stretch portions 126. When fastened together, the female and male member may include metal contacts to connect the wire extending through the non-stretch portion 126 to the batteries in the buckle 122.

In between the at least one illumination strand and the batteries, a switch may be provided for interrupting supply of power from the battery pack to the at least one illumination strand thereby allowing the illumination strand to be switched on or off. In an alternative embodiment, a photocell (or other light sensor) may be provided to detect a level of light and automatically interrupt supply of power from the battery pack to the illumination strands when the level of light is at or above a predetermined level and/or supply of power when the light level is at or below the predetermined level. Accordingly, the photocell may provide an automatic switch option for switching on or off the illumination strands. Additional functionality such as patterned blinking and/or multi-color may be provided by additional switches and/or one or more controllers. In yet another alternative embodiment, the illumination strand may be illuminated for a period and then turned off for a period so as to save battery power. For example, the illumination strand may blink for one second and then dim or turn completely off for two seconds.

The at least one illumination strand 120 may comprise a string or line of Light Emitting Diode (LED) lights. In the embodiment shown, the LED lights may be rounded with a ¼ inch diameter. However, alternative configurations are considered to be within the scope of the present invention. For example, in an alternative embodiment, fiber optic lights may be provided. In yet another alternative embodiment, electroluminescent lighting (EL) may be provided. In the embodiment shown, the at least one illumination strand may comprise clear LED lights. However, alternative configurations are considered to be within the scope of the present invention. For example, the LED lights may be colored or multi-colored. In yet another alternative embodiment, the switch and/or controller may enable blinking or other on-off patterns of illumination and the LED lights may include a red color mode. Together, the blinking of the red LED lights may correspond to an emergency mode whereby a user sets the switch to the emergency mode to indicate medical or other distress.

The belt illumination device 102 is shown in FIG. 5 with indications at a 3 o'clock position 130, a 9 o'clock position 132, an 11 o'clock position 134, and a 1 o'clock position 136. In the embodiment shown, a first one of the rear illumination strands 120 extends from the belt at the 3 o'clock position 130, a second extends from the belt at the 9 o'clock position 132, a third at the 11 o'clock position 134, and a fourth at the 1 o'clock position 136.

FIG. 6 is a perspective view of a belt illumination device 202 according to another embodiment of the present invention. The belt illumination device 202 may be similar to belt illumination device 102. In the interest of brevity, similar aspects and alternatives will not be repeated. In the embodiment of FIG. 6, the belt illumination device 202 may include a stretch portion 224 and a non-stretch portion 226. The stretch portion 224 may extend on a rear of the belt from one end of the non-stretch portion 226 to the other end of the non-stretch portion 226. In the embodiment shown, the non-stretch portion 226 may extend from a position behind (relative to the front of the belt) where one of the rear illumination strands 220 extends from the non-stretch portion 226 to a position beyond where the other rear illumination strands 220 extends from the non-stretch portion. A difference between the embodiment of FIGS. 4 and 5, and the embodiment of FIG. 6, is that the embodiment of FIG. 6 does not include a buckle. Instead of using a buckle to take off and put on the belt illumination device 202, a user may un-attach one end and/or the other of the stretch portion from the non-stretch portion. In the embodiment of FIG. 6, a user may depress tab 290 thereby unfastening the stretch portion from the non-stretch portion. Another difference between the embodiment of FIGS. 4 and 5, and the embodiment of FIG. 6 is that the non-stretch portion 226 may contain the one or more batteries. Finally, the belt illumination device 202 of FIG. 6 is shown with illumination strands at a 2 o'clock position, a 5 o'clock position, a 7 o'clock position, and a 10 o'clock position. It should be appreciated by one of ordinary skill in the art that where the belt illumination device includes at least one illumination strand that is removable from the belt portion such as via the plug and/or fastener assembly, the particular location of attachment of the illumination strand may be athlete configurable. In this way, an athlete may use the belt illumination device with garments having different track locations (e.g., 1, 3, 9, and 11 o'clock positions, and also 2, 5, 7, and 10 o'clock positions, or other appropriate positions). In such an embodiment, the athlete may simply plug-in or attach the illumination strands to the correct receptacles or ports on the belt portion of the belt illumination device. In an alternative embodiment, a design of the illumination device may include a power supply to be worn on the small of the back of the athlete.

Turing back to the track-mounted lower body garment 104, the embodiment shown in FIG. 1 includes four tracks 150. A first one of the tracks begins under a beltline at a 3 o'clock position corresponding to the 3 o'clock position 130 of the belt (of FIGS. 4 and 5). A second one of the tracks begins under the beltline at a 9 o'clock position corresponding to the 9 o'clock position 132 of the belt. A third one of the tracks begins under the beltline at an 11 o'clock position corresponding to the 11 o'clock position 134 of the belt. A fourth one of the tracks begins under the beltline at a 1 o'clock position corresponding to the 1 o'clock position 136 of the belt. In the embodiment shown, the first one of the tracks 150 is attached to the track-mounted lower body garment 150 and runs down the right leg on a side of the leg to a location 160 just above a side of a right knee portion of the track-mounted lower body garment 104. At the location 160 just above the side of the right knee portion, the first one of the tracks 150 curves to the rear of the leg and continues down the back of a calf area 162 of the track-mounted lower body garment 104. In the embodiment shown, the first one of the tracks 150 runs from below the beltline to an inch above the bottom of the garment 104. However, alternative configurations are considered to be within the scope of the present invention. For example, the first and/or others of the tracks 150 may run to a location above the location 160 just above the side of the right knee thereby removing the disclosed curve. In an embodiment where the track-mounted lower body garment 104 comprises running shorts, such a configuration where tracks run to a position above a user's knee may be necessary. Turing back to the embodiment shown, the second one of the tracks 150 is attached to the track-mounted lower body garment 104 and runs down the left leg on a side of the leg to a location just above a side of the left knee portion of the track-mounted lower body garment 104. At the location just above the side of the left knee portion, the second one of the tracks 150 curves to the rear of the leg and continues down the back of a calf area of the track-mounted lower body garment 104. In the embodiment shown, the second one of the tracks 150 runs from below the beltline to an inch above the bottom of the garment 104. The third one of the tracks 150 is attached to the track-mounted lower body garment 104 and runs down a front of the left leg to a location just above a front of the left knee portion of the track-mounted lower body garment 104. At the location just above the front of the left knee portion, the third one of the tracks 150 curves to the side of the leg and continues down the side of the calf area of the track-mounted lower body garment 104. In the embodiment shown, the third one of the tracks 150 runs from below the beltline to an inch above the bottom of the garment 104. The fourth one of the tracks 150 is attached to the track-mounted lower body garment 104 and runs down a front of the right leg to just above a front of the right knee portion of the track-mounted lower body garment 104. At the location just above the front of the right knee portion, the fourth one of the tracks 150 curves to the side of the leg and continues down the side of the calf area of the track-mounted lower body garment 104. In the embodiment shown, the fourth one of the tracks 150 runs from below the beltline to an inch above the bottom of the garment 104.

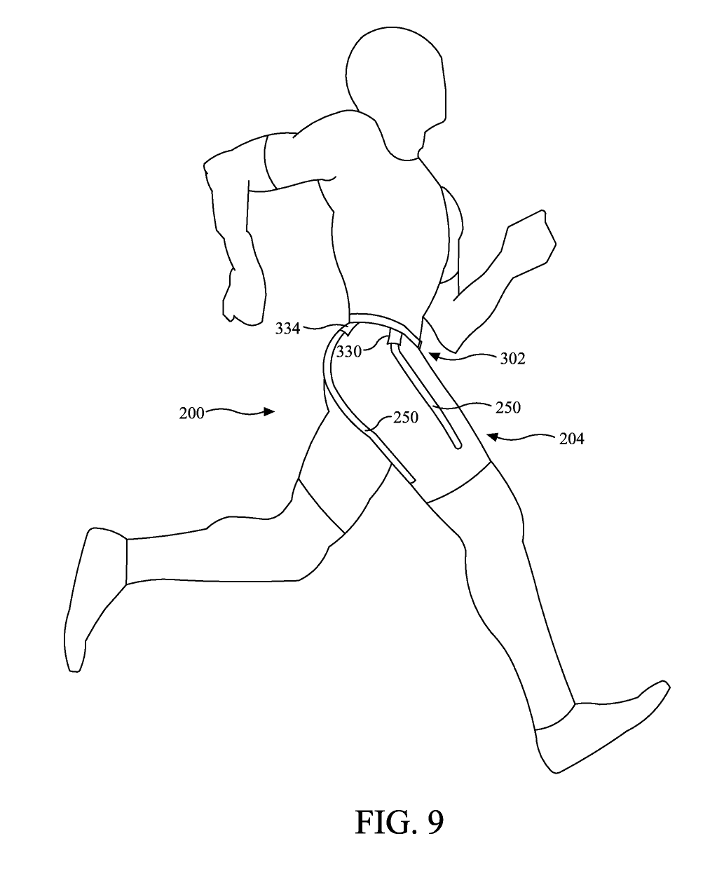

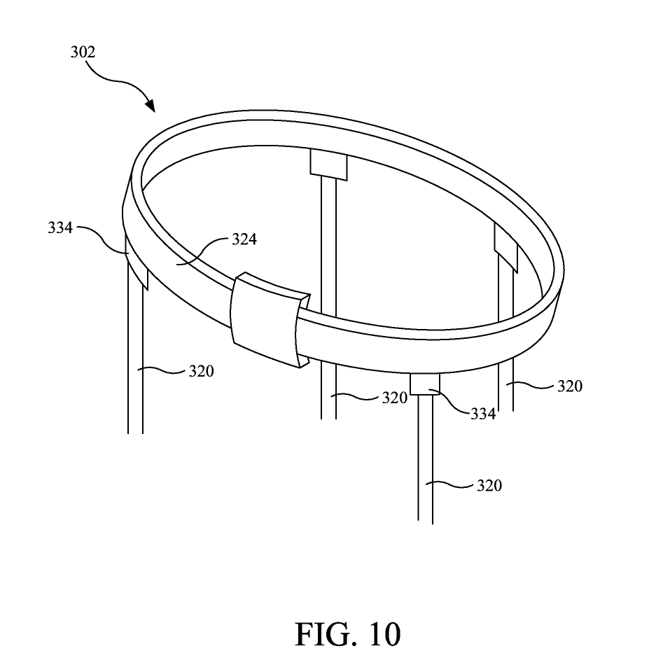

FIG. 9 is a side view of an athletic wear illumination system 200 according to another embodiment of the present invention. The athletic wear illumination system 200 may be similar to the athletic wear illumination system 100 of FIG. 1. In the interest of brevity, similar aspects and alternatives will not be repeated. In the embodiment of FIG. 9, the athletic wear illumination system 200 may include a belt illumination device 302 (FIG. 10) and a track-mounted lower body garment 204. As noted above, the belt illumination device 302 shown may include four illumination strands 320 (FIG. 10) at a 2 o'clock position, a 5 o'clock position, a 7 o'clock position, and a 10 o'clock position of the belt. The track-mounted lower body garment 204 shown in FIG. 9 is a pair of athletic running shorts including four tracks 250. The tracks 250 may include a dove-tail channel 252 such as that shown in FIG. 7B. The dove-tail channel 252 may be adapted to receive the illumination strands 320 of the belt illumination device 302 thereby attaching the illumination device 302 to the track-mounted lower body garment 204. The tracks 250 may run from a few inches (e.g., 1-6 inches) below the beltline of the track-mounted lower body garment 204 down the sides of the lower body garment. In operation, an athlete may put on the track-mounted lower body garment 204 and then put on the belt illumination device 302. The illumination strands 320 may then be easily pressed onto (e.g., in) the dove-tail channels 252 of the tracks 250. After the athlete is finished exercising, the athlete may unfasten the belt illumination device and by pulling the device away from the waist, the illumination strands may come off of (out of) the dove-tail channels 252.

As with the track-mounted lower body garment 104 of FIG. 1, the current embodiment may include tracks 250 placed intentionally for athlete comfort and for increasing visibility of the athlete to others. In contrast to the embodiment of FIG. 1, the tracks 250 may run down the legs of the track-mounted lower body garment 204 without any curves. However, alternative configurations are considered to be within the scope of the present invention. For example, with biking, a certain motion of the legs and knees may differ from the motion of the legs and knees of an athlete that is running. Accordingly, the tracks may include a curve on the leg that allows for such motion.

FIG. 10 is a perspective view of a belt illumination device 302 according to another embodiment of the present invention. The belt illumination device 302 may be similar to belt illumination devices 102, 202. In the interest of brevity, similar aspects and alternatives will not be repeated. The belt illumination device 302 may include a belt portion 324 and illumination strands 320. The illumination strands 320 and the belt 324 may be separated by a non-strand portion 334. The non-strand portion 334 may be formed of wires run in a zigzag pattern within a stretchable fabric. Accordingly, the non-strand portion 334 may provide for maneuverability of the illumination strands relative to the belt 324 to further increase athlete comfort. Stated differently, the non-strand portions 334 may enable the illumination strands to stretch from and retract towards the belt.

Embodiments of the present invention provide for illuminating athletic wear used by runners, walkers, bikers, and other athletes. Embodiments of the present invention may provide for a number of benefits, including providing battery powered illumination for athletes that is comfortable and easy to use for athletes as they exercise. Embodiments may be water resistant or waterproof, and a garment portion of the embodiments may be washable using a normal household clothes washers and clothes dryer. Embodiments of the present invention may be affordable as the belt illumination device and the track-mounted lower body garment may be separate components and interchangeable, such that a user may have different styles and colors of garments that may be used with a single belt illumination device.

The foregoing description discloses only exemplary embodiments of the invention. Modifications of the above-disclosed embodiments of the present invention (beyond those modifications already mentioned) of which fall within the scope of the invention will be readily apparent to those of ordinary skill in the art. For instance, although in some embodiments, a track is described as running from below the beltline down the leg and then in a curved direction rearward, the track may run an alternate direction and/or pattern, such as in a zigzag pattern running at an angle down the track-mounted lower body garment.

As another example, a belt illumination device may not include a traditional belt in the sense of the embodiments of FIGS. 4-6 and 10, but rather may include a wire portion connecting illumination strands to a power pack. In one embodiment, the power pack may be worn in a pocket of a track-mounted lower body garment. The wire portion may be permanently or removably incorporated into a waistband of a track-mounted lower body garment. The waistband may be formed of a stretch portion and the wire portion may be formed of a semi-flexible molded harness. The power pack, wire portion, and illumination strands may be formed as a unitary structure. In yet another alternative embodiment, the power pack, wire portion, and/or illumination strands may be removable from one another such as via plug and/or fastener assemblies.

Accordingly, although embodiments of the present invention have been shown and described, it would be appreciated by those skilled in the art that changes may be made in these embodiments without departing from the principles and spirit of the invention.

1. An athletic wear illumination system, comprising:
a belt illumination device, including a belt and at least one illumination strand extending from the belt; and
a track-mounted lower body garment, including at least one track attached to the track-mounted lower body garment corresponding to the at least one illumination strand,
wherein the at least one illumination strand is adapted to be removably received within the at least one track.

2. The athletic wear illumination system of claim 1, wherein the at least one illumination strand comprises a plurality of illumination strands, and wherein the at least one track comprises a plurality of tracks.

3. The athletic wear illumination system of claim 2, wherein the at least one track comprises at least one member of the group consisting of a transparent cylindrical channel, a flexible dove-tail channel, a series of receptacles, and a series of magnets.

4. The athletic wear illumination system of claim 1, wherein the at least one illumination strand comprises a string or line of Light Emitting Diode (LED) lights.

5. The athletic wear illumination system of claim 1, wherein the at least one illumination strand comprises electroluminescent lighting (EL).

6. The athletic wear illumination system of claim 1, wherein the at least one track begins at or below a beltline of the track-mounted lower body garment and extends down the track-mounted lower body garment to a position at or above a bottom of the track-mounted lower body garment.

7. An athletic wear illumination system, comprising:
a belt illumination device, including a belt and a plurality of illumination strands extending from the belt; and
a track-mounted lower body garment, including a plurality of tracks attached to the track-mounted lower body garment, the plurality of tracks corresponding to the plurality of illumination strands,
wherein the plurality of illumination strands are adapted to be removably received within the plurality of tracks.

8. The athletic wear illumination system of claim 7, wherein the plurality of illumination strands comprise four illumination strands, and wherein the plurality of tracks comprise four tracks.

9. The athletic wear illumination system of claim 8, wherein the four tracks each comprise a flexible dove-tail channel.

10. The athletic wear illumination system of claim 9, wherein the four illumination strands are removably pressed into the flexible dove-trail channels.

11. The athletic wear illumination system of claim 8, wherein the four illumination strands each comprise a string or line of Light Emitting Diode (LED) lights.

12. The athletic wear illumination system of claim 8, wherein the four illumination strands each comprises electroluminescent lighting (EL).

13. The athletic wear illumination system of claim 7, wherein the plurality of tracks begin below a beltline of the track-mounted lower body garment and extends down the track-mounted lower body garment.

14. The athletic wear illumination system of claim 7, wherein the plurality of tracks terminate at a position above a bottom of the track-mounted lower body garment.
